(19) United States
(12) Patent Application Publication
(10) Pub. No.: US 2017/0092211 A1
(43) Pub. Date: Mar. 30, 2017

(54) Array Substrate And Display Driving Method Thereof As Well As Display Device

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Zhuo XU, Beijing (CN); Xiaoyuan WANG, Beijing (CN); Yajie BAI, Beijing (CN); Rui WANG, Beijing (CN); Wu WANG, Beijing (CN); Jaikwang KIM, Beijing (CN)

(21) Appl. No.: 15/142,606

(22) Filed: Apr. 29, 2016

(30) Foreign Application Priority Data
Sep. 28, 2015 (CN) 201510628806.X

(51) Int. Cl. G09G 3/36; G09G 3/20

(52) U.S. Cl. CPC G09G 3/3614; G09G 3/2018; G09G 3/3677; G09G 3/3688; G09G 2300/0426; G09G 2330/021; G09G 2310/027

(57) ABSTRACT

There is provided an array substrate and display driving method thereof, and a display device, wherein the array substrate comprises a common voltage line, a plurality of pixel electrodes arranged in rows and columns, and at least one first transistor arranged between two adjacent pixel electrodes, wherein a gate electrode of first transistor is coupled to the common voltage line, a first electrode of the first transistor is coupled to one of the two adjacent pixel electrodes, and a second electrode of the first transistor is coupled to the other one of the two adjacent pixel electrodes. The disclosure makes it possible to achieve polarity neutralization of grayscale voltages for the adjacent pixels without reducing the pixel aperture ratio, thus significantly reducing power consumption without affecting the display effect and achieving a power consumption even lower than the lowest power consumption achieved by the existing display devices.

### CROSS REFERENCE TO RELATED APPLICATION

This application claims the benefit and priority of Chinese Patent Application No. 201510628806.X filed Sep. 28, 2015. The entire disclosure of the above application is incorporated herein by reference.

### FIELD

The present disclosure relates to an array substrate and display driving method thereof, and a display device.

### BACKGROUND

This section provides background information related to the present disclosure which is not necessarily prior art.

In particular type of working mode with polarity inversion, the grayscale voltages of adjacent pixels in the liquid crystal display (LCD) may have opposite polarities at the same point in time. Based on this, technical solutions have been proposed in the prior art to neutralize the positive and negative voltages on the adjacent data lines before start of a frame, in order to lower down power consumption. In practice, however, the stray capacitance of the data line is of a very small value and the power it consumes is negligible as compared with the power consumed by charging and discharging of the capacitance in a pixel. In this sense, it would be obviously a much more effective way to neutralize polarities of grayscale voltages between adjacent pixels for reducing the power consumption.

Although possible in theory, it is seldom realized in actual layout design. The main reason for this lies in that an additional control signal line is usually required to control the timing for performing polarity neutralization of the grayscale voltages between adjacent pixels, while the additional control signal line inevitably occupies a portion of the area of the pixel opening region, leading to significant loss in the pixel aperture ratio.

### SUMMARY

This section provides a general summary of the disclosure, and is not a comprehensive disclosure of its full scope or all of its features.

The array substrate and display driving method thereof, and display device according to embodiments of the present disclosure make it possible to achieve polarity neutralization of grayscale voltages of the adjacent pixels without reducing the pixel aperture ratio.

According to a first aspect of the present disclosure, there is provided an array substrate comprising a common voltage line, a plurality of pixel electrodes arranged in rows and columns, and at least one first transistor arranged between two adjacent pixel electrodes, wherein a gate electrode of the first transistor is coupled to the common voltage line, a first electrode of the first transistor is coupled to one of the two adjacent pixel electrodes, and a second electrode of the first transistor is coupled to the other one of the two adjacent pixel electrodes.

According to an embodiment of the present disclosure, the array substrate further comprises a plurality of second transistors, a plurality of scanning lines arranged between two adjacent rows of pixel electrodes, and a plurality of data lines arranged between two adjacent columns of pixel electrodes, wherein a gate electrode of one of the plurality of second transistors corresponding to each of the pixel electrodes is coupled to one of the scanning lines, a first electrode is coupled to the pixel electrode, and a second electrode is coupled to one of the data lines.

According to an embodiment of the present disclosure, the at least one first transistors is arranged between two pixel electrodes of the adjacent rows.

According to an embodiment of the present disclosure, a first conductor structure of the first electrode of the second transistor extends through the scanning line and extends towards the adjacent pixel electrode in the same column, so as to form the first electrode of the first transistor, and a second conductor structure coupled to the pixel electrode contacts with an active layer of the first transistor through a via hole, so as to form the second electrode of the first transistor.

According to an embodiment of the present disclosure, the at least one first transistor is arranged between two pixel electrodes of the adjacent columns.

According to an embodiment of the present disclosure, a first conductor structure of the first electrode of the second transistor extends towards the adjacent pixel electrode in the same row, so as to form the first electrode of the first transistor, and a second conductor structure of the first electrode of another second transistor coupled to the pixel electrode extends towards and contacts with an active layer of the first transistor, so as to form the second electrode of the first transistor, and wherein both of the first and second conductor structures are formed outside a region in which the plurality of pixel electrodes are formed.

According to an embodiment of the present disclosure, two scanning lines are arranged between every two adjacent rows of pixel electrodes, and one data line is arranged between every two columns of pixel electrodes.

According to an embodiment of the present disclosure, a conductor layer of the common voltage line overlaps an active layer of each of the at least one first transistor in a region in which the first transistor is formed, so as to form the gate electrode of the first transistor.

According to an embodiment of the present disclosure, the common voltage line is divided into at least two conductor patterns, each of which is connected to an individual common voltage signal.

According to a second aspect of the present disclosure, there is provided a display driving method of any above described array substrate, the method comprising:

applying a voltage to the plurality of pixel electrodes within a display frame, such that two adjacent pixel electrodes connected to the same first transistor have opposite voltage polarities; and

applying a voltage to the common voltage line between adjacent display frames, such that all of the first transistors whose gate electrode is connected to the common voltage line operate in a linear region or a saturation region.

According to a third aspect of the present disclosure, there is provided a display device comprising any above described array substrate.

According to solutions proposed above, the disclosure additionally provides the existing array substrate with a first transistor arranged between two adjacent pixel electrodes and uses a common voltage line to supply the first transistor with a cut-in voltage between adjacent display frames. Accordingly, the common voltage line is a structure which already exists in the existing array substrates and the first transistor arranged between two adjacent pixel electrodes does not occupy the area of the pixel opening region. As a result, the disclosure makes it possible to achieve polarity neutralization of grayscale voltages of the adjacent pixels without reducing the pixel aperture ratio, thus significantly reducing power consumption without affecting the display effect and achieving power consumption even lower than the lowest power consumption achieved by the existing display devices.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustrating a partial structure of an array substrate according to an embodiment of the present disclosure;

FIG. 2 is a schematic view illustrating the circuit connection of an array substrate according to an embodiment of the present disclosure;

FIG. 3 is a schematic view illustrating a circuit structure of an array substrate according to an embodiment of the present disclosure;

FIG. 4 is a cross-sectional view along line A-A′ at the location where the first transistor is positioned in FIG. 3;

FIG. 5 is a schematic view illustrating a circuit structure of an array substrate according to another embodiment of the present disclosure;

FIG. 6 is a cross-sectional view along line A-A′ at the location where the first transistor is positioned in FIG. 5; and

FIG. 7 is a signal timing diagram on the common voltage line according to an embodiment of the present disclosure.

Corresponding reference numerals indicate corresponding parts or features throughout the several views of the drawings.

### DETAILED DESCRIPTION

Example embodiments will now be described more fully with reference to the accompanying drawings.

An embodiment of the present disclosure provides an array substrate comprising a common voltage line, a plurality of pixel electrodes distributed in rows and columns, and at least one first transistor disposed between two adjacent pixel electrodes.

More specifically, FIG. 1 is a schematic view illustrating a partial structure of an array substrate according to an embodiment of the present disclosure. For ease of illustration, FIG. 1 only shows a part of a common voltage line 11, pixel electrodes 12a and 12b of the plurality of pixel electrodes adjacent to each other in the row direction, and a first transistor T1 arranged between the pixel electrodes 12a and 12b. Referring to FIG. 1, the first transistor T1 is connected to the common voltage line 11 via a gate electrode thereof, to the pixel electrode 12a via a first electrode thereof, and to the pixel electrode 12b via a second electrode thereof.

It would be appreciated that the plurality of pixel electrodes distributed in rows and columns may be, for example, a transparent electrode array on the array substrate of the existing LCD panel for providing grayscale voltages to the liquid crystal layers, and that the common voltage line may be, for example, a metal wire positioned outside the pixel opening region on the array substrate of the existing LCD panel for supplying a common terminal voltage. Accordingly, the embodiment of the present disclosure may be implemented by modifying the structure of the array substrate in the existing LCD panel, for example, by adding a first transistor using the common voltage line as its gate electrode, as described above.

According to solutions proposed above, the embodiment of the present disclosure additionally provides the existing array substrate with a first transistor arranged between two adjacent pixel electrodes and uses a common voltage line to supply the first transistor with a cut-in voltage between adjacent display frames. Accordingly, the common voltage line is a structure which already exists in the existing array substrates and the first transistor arranged between two adjacent pixel electrodes does not need to occupy the area of the pixel opening region. As a result, according to the embodiment of the present disclosure, it is possible to achieve polarity neutralization of grayscale voltages for the adjacent pixels without reducing the pixel aperture ratio, thus significantly reducing power consumption without affecting the display effect and achieving power consumption even lower than the lowest power consumption of the existing display devices.

It would be appreciated that the transistors in the described embodiments may be thin-film transistors or any other type of field-effect transistors. If the transistor used is structured such that its source electrode and drain electrode are symmetrical with each other, such source electrode and drain electrode may be considered as two electrodes which are not particularly distinguished. According to an embodiment of the present disclsoure, in order to distinguish two electrodes other than the gate electrode of the transistor, one of the two other electrodes is referred to as a “first” electrode and the other is referred to as a “second” transistor. In addition, depending on its characteristics, the transistor may be classed as N-type transistor or P-type transistor. The various embodiments of the present disclosure will be described by using the N-type transistor. Foresaid first electrode may be a drain electrode of the N-type transistor, while foresaid second electrode may be a source electrode of the N-type transistor. Moreover, on the basis of the description and teachings regarding to implementation of the N-type transistor, the skilled person would readily envisage using P-type transistor to equivalently replace the N-type transistor. The present disclosure does not make restriction to this.

It would be appreciated that the array substrate according to the embodiments of the present disclosure may be identical with that used in the existing display device and may comprise a substrate and a layered circuit structure disposed on the substrate. In addition to foresaid common voltage line, the plurality of pixel electrodes and the at least one first transistor, this layered circuit structure may further comprise a plurality of second transistors, a plurality of scanning lines disposed every two adjacent rows of pixel electrodes, and a plurality of data lines disposed between two adjacent columns of pixel electrodes. For each of the pixel electrodes, one second transistor is connected to one scanning line via a gate electrode thereof, to one pixel electrode via a first electrode thereof, and to one data line via a second electrode thereof. Thereby, when a scanning driving signal is outputted on a scanning line, a current flow will be formed between the first and second electrodes of the second transistor which is connected to said scanning line via its gate electrode, such that the grayscale voltages from multiple data lines are written into the pixel electrodes connected thereto. As the scanning driving signals are successively outputted on multiple scanning lines, grayscale voltages of the corresponding pixel electrodes are successively outputted to multiple data lines, whereby the grayscale voltages of all pixel electrodes can be written within one display frame.

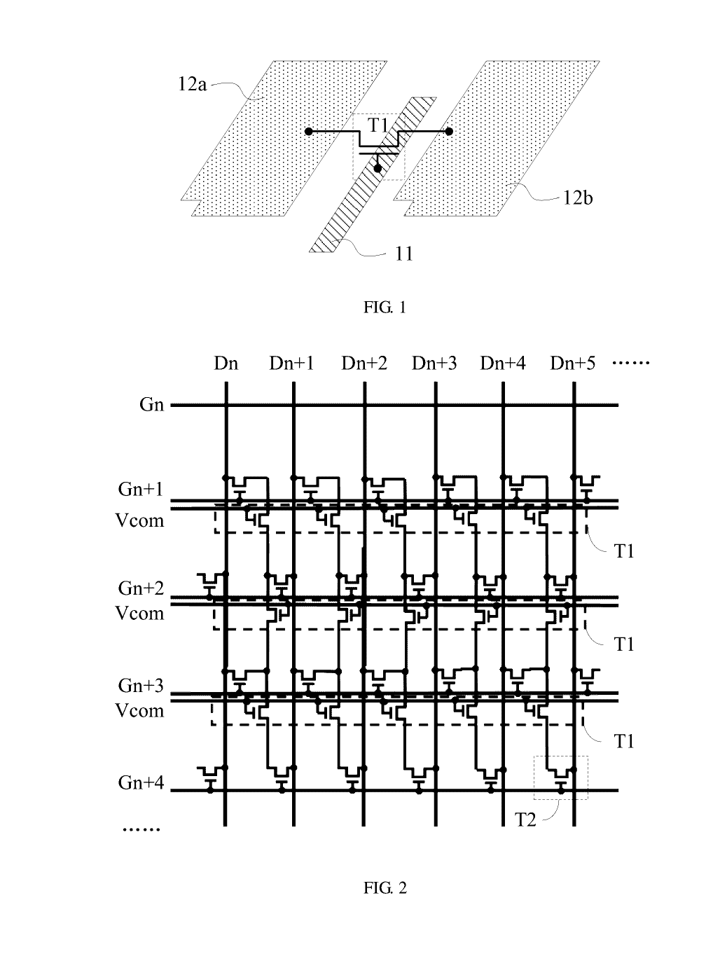

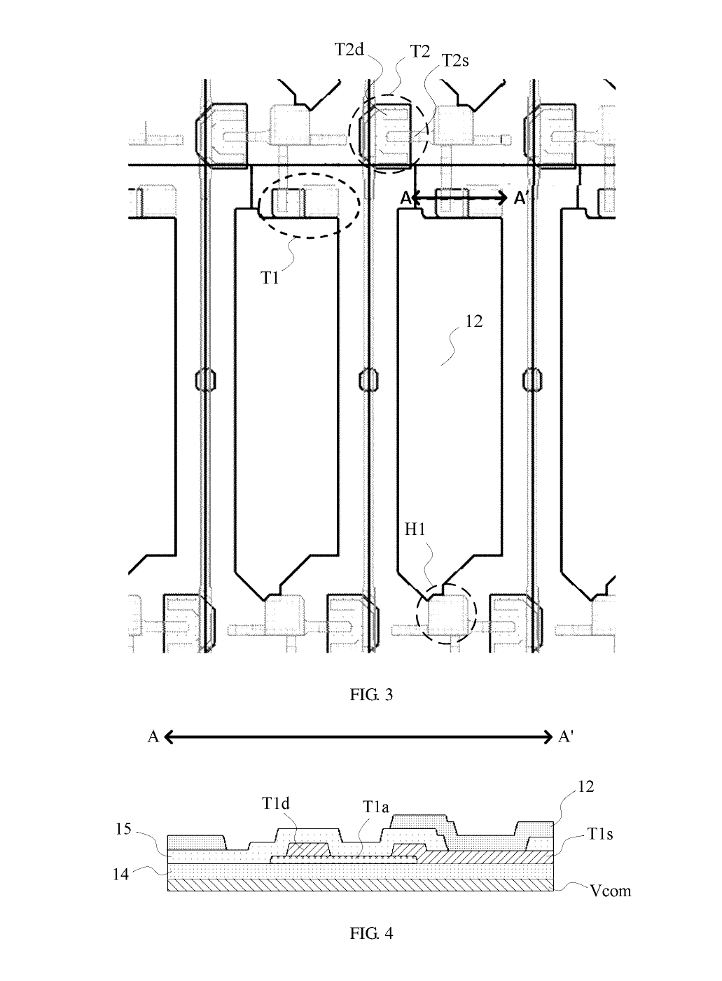

More specifically, FIG. 2 is a schematic view illustrating the circuit connection of an array substrate according to an embodiment of the present disclosure. Turning now to FIG. 2, the array substrate according to an embodiment of the present disclosure comprises a plurality of scanning lines Gn, Gn+1, Gn+2, Gn+3 and Gn+4, and a plurality of data lines Dn, Dn+1, Dn+2, Dn+3, Dn+4 and Dn+5, such that the plurality of pixel electrodes are disposed one-by-one in one of a plurality of rectangular pixel regions formed by crossing the plurality of scanning lines with the plurality of data lines (for ease of illustration, the pixel electrodes are not shown in FIG. 2). In each of the pixel regions, the second transistor T2 is connected to a scanning line via the gate electrode thereof, to the pixel electrode via the first electrode thereof, and to a data line via the second electrode thereof, such that the grayscale voltages on the data line can be conducted to the pixel electrode under on-state. It would be appreciated that in any of the second transistors T2 as shown in FIG. 2, one of the two electrodes (other than the gate electrode) which is not connected to the data line is taken as the first electrode connected to the pixel electrode. Therefore, when the common voltage line Vcom to which the gate electrode of the first transistor T1 is connected supplies a cut-in voltage to the first transistor T1, the first transistor T1 connected between first electrodes of two adjacent rows of second transistors T2 in the same column conducts two adjacent pixel electrodes in the same column, thus realizing polarity neutralization of the grayscale voltages.

More specifically, FIG. 3 is a schematic view illustrating a circuit structure of an array substrate according to an embodiment of the present disclosure. Referring to FIG. 3, it can be seen that the circuit connection shown is consistent with that shown in FIG. 2. According to the illustrated embodiment, the U-shaped second electrode T2d of the second transistor T2 is connected to a vertically extending data line. Surrounded by the U-shaped second electrode T2d, the bar-shaped first electrode T2s forms a connection with a corresponding pixel electrode 12 within the first via hole region H1. An active layer contacting with the second electrode T2d and the first electrode T2s respectively is formed within the U-shaped region between the second electrode T2d and the first electrode T2s. A conductor pattern serving as the gate electrode of the second transistor T2 is disposed in the region where the second transistor T2 is located, and this conductor pattern is separated from each of the active layer, the second electrode T2d and the first electrode T2s by a gate insulating layer, so as to keep electrical insulation therebetween. In addition, within the first via hole region H1, the via hole connected between the first electrode T2s and the corresponding pixel electrode 12 is formed in a passivation layer covering the active layer, the second electrode T2d and the first electrode T2s.

In another aspect, the first transistor T1 shown in FIG. 3 is disposed between two pixel electrodes 12 arranged in adjacent rows and in the same column. FIG. 4 is a cross-sectional view along line A-A′ at the location where the first transistor is positioned in FIG. 3. Referring to FIG. 4, at this location a pattern of the common voltage line Vcom is provided and this pattern is covered by the gate insulating layer 14. The active layer T1a of the first transistor T1 is formed on the gate insulating layer 14 in a region corresponding to the pattern of the common voltage line Vcom. The first electrode T1d and the second electrode T1s of the first transistor T1 contact with the active layer T1a at different positions, respectively. It would be appreciated that the conductor layer comprising the common voltage line Vcom overlaps the active layer T1a of the first transistor T1 in the region where the first transistor T1 is formed, so as to form the gate electrode of the first transistor T1. For purpose of electrical insulation, the passivation layer 15 covers over the active layer T1a, the first electrode T1d and the second electrode T1s. The pixel electrode 12 is formed on the passivation layer 15, and the passivation layer 15 is provided with a via hole for connecting the second electrode T1s and the pixel electrode 12. It can be seen that the common voltage line Vcom overlaps the pixel electrode 12, whereby a storage capacitor corresponding to the pixel electrode 12 is formed, such storage capacitor can be used to stabilize potential on the pixel electrode 12 after the grayscale voltages have been written.

As seen from FIGS. 3-4, a first conductor structure comprising the first electrode T2s of a second transistor T2 passes through a scanning line and extends towards an adjacent pixel electrode 12 in the same column, so as to form the first electrode T1d of the first transistor T1; a second conductor structure connected to the pixel electrode 12 contacts with an active layer T1a of the first transistor by a via hole, so as to form the second electrode T1s of the first transistor. It would be appreciated that the array substrate structure illustrated in FIGS. 3 and 4 can be obtained by making simple modification to the existing array substrate structure without affecting the pixel aperture ratio.

More specifically, the common voltage line Vcom serving as the gate electrode of the first transistor T1 may originally function as an electrode plate of the storage capacitor and partially overlap the pixel electrode 12, therefore it is possible to form the via hole connected between the second electrode T1s and the pixel electrode 12 in the passivation layer 15 within the overlapping region and to additionally arrange the active layer T1a and the second electrode T1s in the corresponding region. In another aspect, the first electrode T1d of the first transistor may be formed by the first electrode T2s of the second transistor T2 extending through a scanning line, whereby the formation of the first transistor T1 may be achieved by modifying patterns on the mask plate corresponding to the respective layered structures without requiring any extra processing. Meanwhile, the first transistor T1 may be formed outside the pixel opening region of the existing array substrate structure, therefore, the pixel aperture ratio would not be affected.

It would be appreciated that although in the array substrate shown in FIGS. 3 and 4, at least one first transistor T1 is disposed between two pixel electrodes arranged in adjacent rows and in the same column, it is possible in other embodiments of the present disclosure that at least one first transistor T1 may be disposed between two pixel electrodes arranged in adjacent columns and in the same row, or disposed in any other suitable manner. The first transistor may achieve the polarity neutralization only when the grayscale voltages of the two pixel electrodes connected by said first transistor have grayscale voltages with opposite polarities, therefore, the configuration of the first transistor may be determined according to the polarity inversion mode specifically adopted. The present disclosure does not make restriction to this.

For example, FIG. 5 is a schematic view illustrating a circuit structure of an array substrate according to another embodiment of the present disclosure. It can be seen that the structure of the pixel electrode and the second transistor, as well as the connection between the pixel electrode and the second transistor as illustrated in FIG. 5 is the same with those illustrated in FIG. 3. For example, the second transistor T2 in FIG. 5 is connected to the pixel electrode 12a via the first via hole region H1 within the pixel region where the second transistor T2 is located, and thus are not described in details here. Different from the array substrate shown in FIG. 3, however, in FIG. 5 there are two scanning lines arranged every two adjacent rows of pixel electrodes, and one data line is disposed every two columns of pixel electrodes that are connected. For example, two scanning lines may be provided above and below the pixel electrodes 12a, 12b, respectively. There may be no data line between the pixel electrodes 12a and 12b, but the pixel electrode 12a is provided with a data line at the left side thereof and the pixel electrode 12b is provided with a data line at the right side thereof. Therefore, the second transistor T2 connected to the pixel electrode 12a is connected to the data line adjoining the left side of the pixel electrode 12a, the gate electrode of the second transistor T2 is connected to the scanning lines adjoining lower side of the pixel electrode 12a. The second transistor T2 connected to the pixel electrode 12b is connected to the data line adjoining the right side of the pixel electrode 12a, the gate electrode of the second transistor T2 is connected to the scanning lines adjoining upper side of the pixel electrode 12b. Accordingly, the structure shown in FIG. 5 forms a dual-gate pixel arrangement.

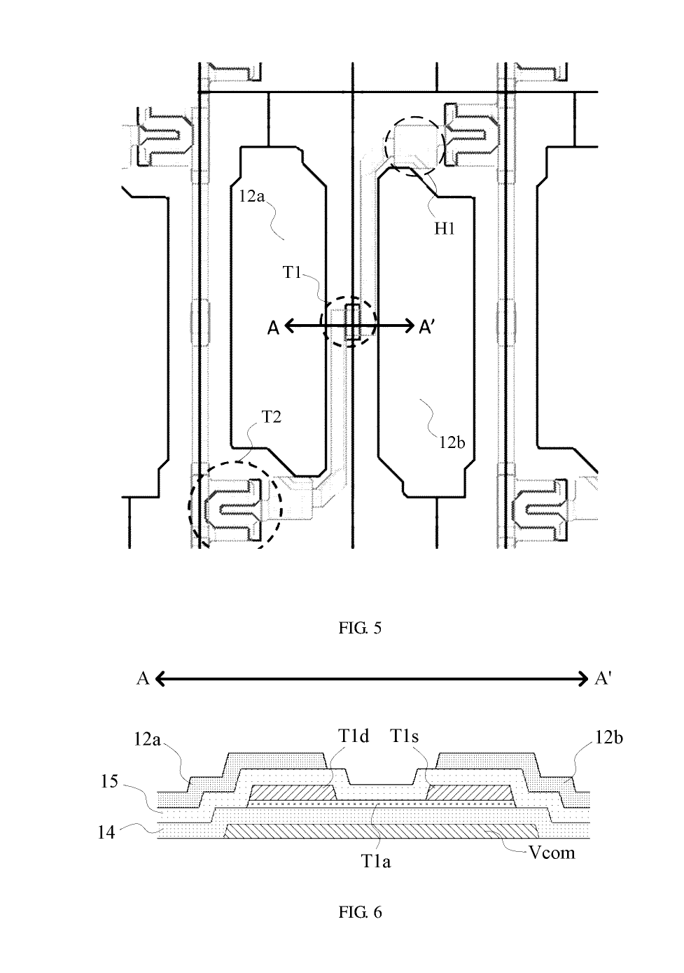

Based on this, at least one first transistor may be arranged at the position shown in FIG. 5. More specifically, FIG. 6 is a cross-sectional view along line A-A′ at the location where the first transistor is arranged in FIG. 5. Referring to FIGS. 5-6, the pattern of the common voltage line Vcom passes through the region between the pixel electrode 12a and the pixel electrode 12b and is covered by the gate insulating layer 14. The active layer T1a of the first transistor T1 is formed on the gate insulating layer 14 in a region corresponding to the pattern of the common voltage line Vcom. The first electrode T1d and the second electrode T1s of the first transistor T1 contact with the active layer T1a at different positions, respectively. It would be appreciated that the conductor layer comprising the common voltage line Vcom overlaps the active layer T1a of the first transistor T1 in the region where the first transistor T1 is formed, so as to form the gate electrode of the first transistor T1. For purpose of electrical insulation, the passivation layer 15 covers over the active layer T1a, the first electrode T1d and the second electrode T1s, the pixel electrodes 12a, 12b are formed on the passivation layer 15. Also, it would be appreciated that the common voltage line Vcom between the pixel electrode 12a and the pixel electrode 12b may overlap the pixel electrode 12a and/or the pixel electrode 12b at other positions, whereby a storage capacitor corresponding to the pixel electrode 12a and/or the pixel electrode 12b is formed, such storage capacitor can be used to stabilize potential on the pixel electrode 12a and/or the pixel electrode 12b after the grayscale voltages have been written.

As illustrated in FIGS. 5-6, a first conductor structure comprising the first electrode of a second transistor T2 (passing through the first via hole region H1) extends towards an adjacent pixel electrode 12b arranged in the same row, so as to form the first electrode T1d of the first transistor T1. A second conductor structure comprising the first electrode of another second transistor T2 connected to the pixel electrode 12b extends towards and contacts with the active layer T1a of the first transistor T1, so as to form the second electrode T1s of the first transistor T1; wherein both of the first and second conductor structures bypass the regions in which the pixel electrodes 12a, 12b are formed. It would be appreciated that the array substrate structure illustrated in FIGS. 5 and 6 can be obtained by making simple modification to the existing array substrate structure without affecting the pixel aperture ratio.

In particular, the common voltage line Vcom may be disposed between two pixel electrodes that are adjacent to each other in the row direction in the dual-gate pixel arrangement for the purpose of forming the storage capacitor. On this basis, the active layer T1a of the first transistor T1 may be formed at the corresponding position, the first electrode T1d of the first transistor T1 may be formed by extending the first electrode of a second transistor T2, and the second electrode T1s of the first transistor T1 may be formed by extending the first electrode of another second transistor T2. Accordingly, the formation of the first transistor T1 may be achieved by modifying patterns on the mask plate corresponding to the respective layered structures without requiring any extra processing. Meanwhile, the first transistor T1 may be formed outside the pixel opening region of the existing array substrate structure, therefore, the pixel aperture ratio would not be affected.

It would be appreciated that the circuit structure shown in FIGS. 3-4 does not satisfy with the dual-gate pixel arrangement shown in FIGS. 5-6. However, the first transistor in the array substrate with a dual-gate pixel arrangement may also be configured in the way similar to that illustrated in FIGS. 3-4.

Based on the various exemplary array substrate structures described above, it would be appreciated that the embodiments of present disclosure may be implemented in any existing array substrate comprising a common voltage line and pixel electrodes in the way as illustrated in FIG. 1. The present disclosure does not make restriction to this. In addition, in any first transistor, the gate electrode may be formed by overlapping of an active layer and a conductor layer which comprises a common voltage line and is connected to a common voltage.

For any of the above described array substrates, an embodiment of the present disclosure provides a display driving method for said array substrate, the method comprising the following steps of:

applying voltages to a plurality of pixel electrodes within a display frame, such that two adjacent pixel electrodes connected to the same first transistor have opposite voltage polarities; and

applying a voltage to the common voltage line between adjacent display frames, such that all first transistors whose gate electrode is connected to the common voltage line operate in a linear region or a saturation region.

It would be appreciated the polarity neutralization of the grayscale voltages may be carried out between adjacent display frames. As a result, the power consumption may be significantly reduced without affecting the display effect.

Broadly speaking, however, the time range of a display frame of pixels connected to the same scanning line refers to a range starting from the completion of one grayscale voltage writing to the start of next grayscale voltage writing. To maximize the display effect, it is desirable to divide the common voltage lines into multiple lines which are not connected to one another and arrange them with regard to every row (or every two rows) of scanning line, such that the foresaid steps may particularly include: within a predefined period of time prior to writing grayscale voltages of the pixel electrodes connected to any row (or any two rows) of scanning line, applying a voltage to the common voltage line corresponding to the row(s) of scanning line, such that these pixel electrodes are subjected to grayscale voltages polarity neutralization through the corresponding first transistors. Therefore, it is desirable that the time at which the polarity neutralization is performed is prior to each writing of the grayscale voltages, in order to avoid any potential display problem.

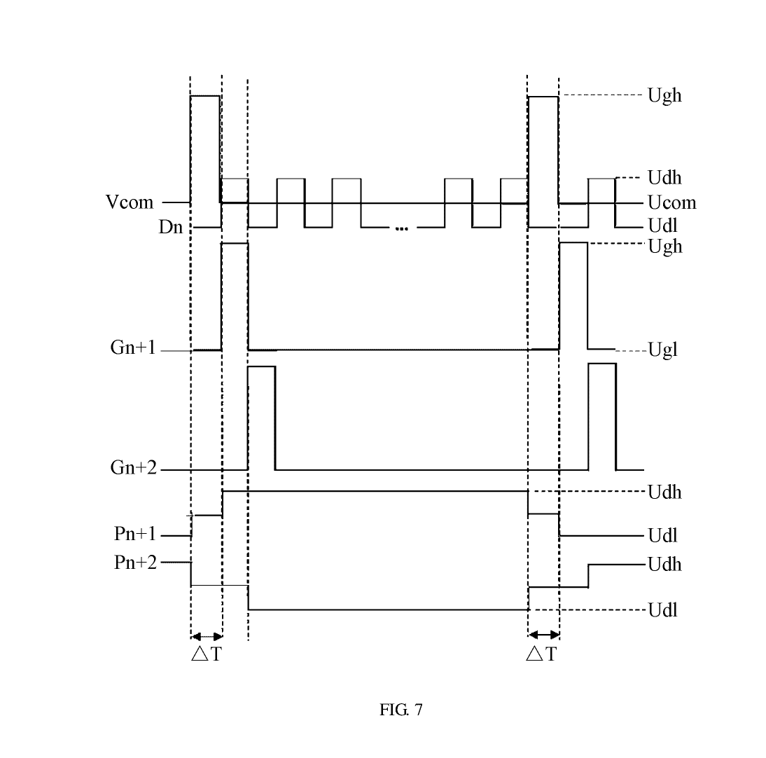

FIG. 7 is a signal timing diagram on the common voltage line Vcom according to an embodiment of the present disclosure. More specifically, FIG. 7 illustrates signal timing at various circuit nodes in FIG. 2 such as date line Dn, scanning line Gn+1, scanning line Gn+2, common voltage line Vcom to which the gate electrodes of the first row of first transistors T1 are connected, pixel electrodes Pn+1 to which the second transistor connected to the scanning line Gn+1 and the data line Dn is connected, and pixel electrodes Pn+2 to which the second transistor connected to the scanning line Gn+2 and the data line Dn is connected. It can be seen that normally the scanning line Gn+1 and the scanning line Gn+2 are at the transistor turn-off voltage Ug1, while during the writing of the grayscale voltages, they are at the transistor cut-in voltage Ugh to generate scanning driving signals successively outputted on multiple scanning lines. As an example, with transferring of the scanning driving signals, the grayscale voltage on the data line Dn is always inverted between the maximum positive grayscale voltage Udh and a maximum negative grayscale voltage Ud1, resulting in a polarity inversion mode such as row inversion or dot inversion.

When the voltage on the scanning line Gn+1 is at Ugh, the second transistor whose gate electrode is connected to the scanning line Gn+1 is turned on, such that a grayscale voltage having the same potential as Udh is written into the pixel electrode Pn+1 and is retained thereafter by the storage capacitor to which the pixel electrode Pn+1 is connected. Similarly, when the voltage on the scanning line Gn+2 is at Ugh, the second transistor whose gate electrode is connected to the scanning line Gn+2 is turned on, such that a grayscale voltage having the same potential as Ud1 is written into the pixel electrode Pn+2. Subsequently, during the reset phase ΔT prior to next writing of grayscale voltage into the pixel electrode Pn+1, the common voltage line Vcom shifts from the normal common voltage Ucom to the transistor cut-in voltage Ugh, whereby the first row of first transistors T1 shown in FIG. 2 are turned on which, in turn, conducts the pixel electrode Pn+1 and the pixel electrode Pn+2, such that Udh and Ud1 having the same potential but opposite polarities are neutralized as the common voltage Ucom. Due to this, the potential on the pixel electrode Pn+1 would not experience dropping from Udh to Ud1 and the potential on the pixel electrode Pn+2 would not experience rising from Ud1 to Udh during the subsequent writing of grayscale voltage. Since the magnitude of variation in potential is reduced, the writing process for grayscale voltage is provided with shorter response time and lower power consumption. As a result, the embodiment of the present disclosure makes it possible to achieve polarity neutralization of grayscale voltages for the adjacent pixels, thus significantly reducing power consumption without affecting the display effect and achieving a power consumption even lower than the lowest power consumption achieved by the existing display devices.

It should be noted that in some embodiments, the signal timing on the common voltage line Vcom to which the gate electrodes of the first row of first transistors T1 are connected can be configured for all pixel electrodes with reference to the configuration made to the pixel electrode Pn+1 and pixel electrode Pn+2 as illustrated in FIGS. 2 and 7, such that the reset phase ΔT is immediately prior to the start of writing the grayscale voltage into the pixel electrode Pn+1 and pixel electrode Pn+2. To this end, it is necessary to divide the conductor layer where the existing common voltage line is located and to apply different signals to the respective portions insulated from each other. In other words, the common voltage lines in the array substrate according to any of the above described embodiments may be divided into at least two conductor patterns, each of which is connected to an individual common voltage signal. Of course, since the present disclosure is different from the prior art in the common voltage signals inputted to the common voltage lines in the array substrate, the circuit in the prior art shall not be used when inputting common voltage to, for example, other components on a color film substrate, such as a common electrode.

It would be appreciated that general polarity inversion modes in conformity with this step include row inversion, column inversion and dot inversion. The person skilled in the art may select a suitable mode according to practical needs and the present disclosure does not make restriction to this.

The present disclosure further provides a display device comprising any array substrate as described above. Such display device is therefore capable of achieving polarity neutralization of grayscale voltages for the adjacent pixels without reducing the pixel aperture ratio, thus significantly reducing power consumption without affecting the display effect and achieving a power consumption even lower than the lowest power consumption achieved by the existing display devices.

It would be appreciated that the display device according to this embodiment may be any product or component with display function, such as a display panel, an electronic paper, a mobile phone, a tablet, a TV, a laptop, a digital frame, a navigator, etc.

It is to be understood that the terms such as “top”, “bottom” used herein are only used to simplify description of the present disclosure, and do not indicate or imply that the device or element referred to must have or operated in a particular orientation. They cannot be interpreted as limits to the present disclosure. In the description of the present disclosure, unless otherwise clearly defined and limited, the term “installation”, “connected”, “connection” should be broadly understood. For example, it can be a fixed connection, it can be a removable connection, or an integral connection. It may be a mechanical connection, or may be an electrical connection. It may be a direct connection, or may be an indirect connection through an intermediary, or intercommunication between two elements. For those of ordinary skill in the art, it will be understood that the specific meaning of these terms in the present disclosure shall depend on the context.

A number of specific details have been described in the specification provided herein. However, it should be understood that the embodiments of the present disclosure may be implemented without these specific details. In some examples, in order not to confuse the understanding of the specification, the known methods, structures and techniques are not shown in detail.

Similarly it should be appreciated that in the description of exemplary embodiments of the disclosure, various features of the disclosure are sometimes combined together in a single embodiment, figure, or description thereof for the purpose of downsizing the disclosure and aiding for the understanding of one or more of the various aspects. This method of disclosure, however, is not to be interpreted as reflecting an intention that the claimed invention requires more features than are expressly recited in each claim. Rather, as the following claims reflect, the aspects may include less features rather than all features of a single foregoing disclosed embodiment. Thus, the accompanying claims are hereby expressly incorporated into this detailed description, with each claim standing on its own as a separate embodiment of this disclosure.

It is to be noted that the above embodiments illustrate rather than limit the disclosure, and those skilled in the art may design alternative embodiments without departing the scope of the accompanying claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a means claim enumerating several devices, several of the devices may be embodied by one hardware item. Use of the word “first”, “second”, and “third”, etc. does not mean any ordering. Such words may be interpreted as naming.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An array substrate comprising a common voltage line, a plurality of pixel electrodes arranged in rows and columns, and at least one first transistor arranged between two adjacent pixel electrodes, wherein a gate electrode of the first transistor is coupled to the common voltage line, a first electrode of the first transistor is coupled to one of the two adjacent pixel electrodes, and a second electrode of the first transistor is coupled to the other one of the two adjacent pixel electrodes.

2. The array substrate according to claim 1, further comprising a plurality of second transistors, a plurality of scanning lines arranged between two adjacent rows of pixel electrodes, and a plurality of data lines arranged between two adjacent columns of pixel electrodes, wherein a gate electrode of one of the plurality of second transistors corresponding to each of the pixel electrodes is coupled to one of the scanning lines, a first electrode is coupled to the pixel electrode, and a second electrode is coupled to one of the data lines.

3. The array substrate according to claim 2, wherein the at least one first transistors is arranged between two pixel electrodes of the adjacent rows.

4. The array substrate according to claim 3, wherein a first conductor structure of the first electrode of the second transistor extends through the scanning line and extends towards the adjacent pixel electrode in the same column, so as to form the first electrode of the first transistor, and a second conductor structure coupled to the pixel electrode contacts with an active layer of the first transistor through a via hole, so as to form the second electrode of the first transistor.

5. The array substrate according to claim 2, wherein at least one of the first transistors is arranged between two pixel electrodes of the adjacent columns.

6. The array substrate according to claim 5, wherein a first conductor structure of the first electrode of the second transistor extends towards the adjacent pixel electrode in the same row, so as to form the first electrode of the first transistor, and a second conductor structure of the first electrode of another second transistor coupled to the pixel electrode extends towards and contacts with an active layer of the first transistor, so as to form the second electrode of the first transistor, and wherein both of the first and second conductor structures are formed outside a region in which the plurality of pixel electrodes are formed.

7. The array substrate according to claim 6, wherein two scanning lines are arranged between every two adjacent rows of pixel electrodes, and one data line is arranged between every two columns of pixel electrodes.

8. The array substrate according to claim 1, wherein a conductor layer of the common voltage line overlaps an active layer of each of the at least one first transistor in a region in which the first transistor is formed, so as to form the gate electrode of the first transistor.

9. The array substrate according to claim 1, wherein the common voltage line is divided into at least two conductor patterns, each of which is connected to an individual common voltage signal.

10. A display driving method for driving an array substrate according to claim 1, comprising:
applying a voltage to the plurality of pixel electrodes within a display frame, such that two adjacent pixel electrodes connected to the same first transistor have opposite voltage polarities; and
applying a voltage to the common voltage line between adjacent display frames, such that all of the first transistors whose gate electrode is connected to the common voltage line operate in a linear region or a saturation region.

11. A display device comprising an array substrate according to claim 1.

12. A display device comprising an array substrate according to claim 2.

13. A display device comprising an array substrate according to claim 3.

14. A display device comprising an array substrate according to claim 4.

15. A display device comprising an array substrate according to claim 5.

16. A display device comprising an array substrate according to claim 6.

17. A display device comprising an array substrate according to claim 7.

18. A display device comprising an array substrate according to claim 8.

19. A display device comprising an array substrate according to claim 9.
